(19) United States
(12) Patent Application Publication
(10) Pub. No.: US 2020/0042793 A1
(43) Pub. Date: Feb. 6, 2020

(54) CREATING, MANAGING AND ACCESSING SPATIALLY LOCATED INFORMATION UTILIZING AUGMENTED REALITY AND WEB TECHNOLOGIES

(71) Applicant: Ario Technologies, Inc., Norfolk, VA (US)

(72) Inventors: Andrew GOTOW, Lebanon, NH (US); Tomasz FOSTER, West Lebanon, NH (US); Nathan FENDER, Norfolk, VA (US); Jacob GALITO, Norfolk, VA (US); Joseph WEAVER, Norfolk, VA (US)

(21) Appl. No.: 16/525,418

(22) Filed: Jul. 29, 2019

Related U.S. Application Data
(60) Provisional application No. 62/712,626, filed on Jul. 31, 2018.

(51) Int. Cl. G06K 9/00; G06F 3/14; G06F 21/60; G06F 21/62

(52) U.S. Cl. CPC G06K 9/00671; G06F 3/1454; G06F 2221/2141; G06F 21/62; G06F 21/604

(57) ABSTRACT

A system and method creating, managing and/or accessing spatially located information utilizing augmented reality and web technologies is provided, and as described herein, gives users an ability to locate and access correct information as it relates to real-world locations and objects associated or within the real-world locations. Digital content can be created and managed through the system and methods described herein to ensure accessibility both at real-world locations(s) and remotely via a network such as the web portal.

### CROSS REFERENCE TO RELATED APPLICATIONS

This is an application of claims benefit and priority to U.S. Provisional Patent Application No. 62/712,626, filed Jul. 31, 2018, entitled “CREATING, MANAGING AND ACCESSING SPATIALLY LOCATED INFORMATION UTLIZING AUGMENTED REALITY AND WEB TECHNOLOGIES,” the disclosure of which is hereby incorporated herein by reference in its entirety.

### BACKGROUND OF THE DISCLOSURE

### 1.0 Field of the Disclosure

The present disclosure relates generally to creating and managing digital information, and accessing spatially located digital information utilizing augmented reality and web technologies, among other features.

### 2.0 Related Art

People often have great difficulty understanding real-world locations and objects within them, especially when, e.g., performing equipment maintenance and making decisions based on situational awareness. Often, people must use guess-work internet research to understand objects within their environments which leads to misunderstanding, slow, inaccurate, and potentially unsafe performance when interacting with objects. Currently paper-based and digital manuals for understanding objects exist, but the process to properly locate and ensure that proper documentation is accessed is limited.

The benefits of the present disclosure include enabling users to locate or have access to spatially correlated content, and to capture and share subject matter, on-site and in real-time. This may lead to increased efficiency and safety.

### SUMMARY OF THE DISCLOSURE

In one aspect, the present disclosure includes a method and/or system for providing augmented reality overlays along with additional digital content to mobile devices at a real-world location based on a Pip and Pip Codes.

In one aspect, a computer-implemented method of providing augmented reality, includes creating at a first computer a placed information point (Pip) and associating a Pip code with the Pip, associating at the first computer digital content with the Pip and the Pip code, receiving at the first computer, scanned information from a Pip code, and providing by the first computer an augmented reality overlay for displaying on a display. The computer-implemented method may further comprising providing additional digital content associated with the Pip code for displaying on a display of a mobile device. The digital information or the additional digital content may comprise at least one of: a manual, a video, a photo, a document, a 3D model, a 3D asset, sensor data, a hyper-link, a uniform resource locator (URL), audio, a guide, a technical bulletin and an annotated image. The additional digital content may be filtered based on a tag so that only additional content is displayed based on an identifier associated with a user. The computer-implemented method may further comprise applying a permission to a plurality of users for the Pip to control access to the digital content associate with the Pip. The first computer may be a server and the Pip, Pip code, digital content may be stored in a database accessible by the server. The computer-implemented method may further comprise updating the augmented reality overlay to reflect movement of a mobile device relative to an origin point defined by the Pip code. The step of providing augmented reality may include using visual-inertial odometry prior to providing the augmented reality for displaying on the display. The Pip may be a child Pip and the additional digital content may be associated with the child Pip. The computer-implemented method may further comprise receiving at least one tag definition at the first computer and associating the tag with a Pip to filter information based on a user identity or a group identity. The step of providing by the first computer the augmented reality overlay, may provide the augmented reality overlay to a second computer for displaying on a display at the second computer. The first computer may be a camera-equipped mobile device in communication with a server.

In one aspect, a system for providing augmented reality includes a first computer device operably connected to a database that stores data for defining at least one Pip, at least one Pip code, and digital content associated with the at least one Pip, and a second computer device that is equipped to scan a Pip code and equipped to communicate the Pip code to the first computer, wherein the first computer device provides at least one augmented overly to the second computer for displaying on a display. The Pip code may establish an origin point for providing changes in perspective view of the augmented overlay at the second computer device. The second computer device may change the perspective view of the augmented overlay as the second computer device moves. The second computer device may image a real-world location to provide images to be associated with a Pip. The first computer device may manage users and establishes permissions for permitting access by users to the at least one Pip. The first computer device may create at least one child Pip associated with the at least one Pip. The first computer device may provide the digital content to the second computer based on a scanned Pip code. The digital content may comprise at least one of: a hyper-link, a URL, a file, text, a video, a manual, a photos, a 3D model, 3D assets, sensor data, a diagram.

In one aspect, a computer program product comprising software code in a computer-readable medium, that when read and executed by a computer, causes the following steps to be performed: creating at a first computer a placed information point (Pip) and associating a Pip code with the Pip, associating at the first computer digital content with the Pip and the Pip code, receiving at the first computer, scanned information from a Pip code, and providing by the first computer an augmented reality overlay for displaying on a display and providing additional digital content associated with the Pip.

### BRIEF DESCRIPTION OF THE DRAWINGS

The accompanying drawings, which are included to provide a further understanding of the disclosure, are incorporated in and constitute a part of this specification, illustrate embodiments of the disclosure and, together with the detailed description, serve to explain the principles of the disclosure. No attempt is made to show structural details of the invention in more detail than may be necessary for a fundamental understanding of the disclosure and the various ways in which it may be practiced.

FIG. 1A is an example illustration of a person looking at a physical object to read a Pip using a camera-equipped device, according to principles of the disclosure;

FIG. 1B is an example illustration of augmented reality information displayed on mobile camera-equipped device, according to principles of the disclosure;

FIG. 2 is an example illustration of augmented reality information of FIG. 1B re-displayed in relation to the Pip code, according to principles of the disclosure;

FIG. 3 is another example illustration of augmented reality information displayed on a mobile camera-equipped device in relation to a physical object; in this situation, a fire extinguisher, according to principles of the disclosure;

FIG. 4 is an illustration of an example graphical user interface for managing a Pip through a web portal, configured according to principles of the disclosure;

FIG. 5 is an example of managing media attachments for Pips that are in real-world locations, according to principles of the disclosure;

FIG. 6A is an illustration of scanning a Pip code at a real world location, according to principles of the disclosure;

FIG. 6B is an illustration of a Pip code being acknowledged after being scanned by the mobile device and received by the server, according to principles of the disclosure;

FIG. 6C is an illustration of children Pips that are associated with the Pip Code “Tester 2, according to principles of the disclosure;

FIGS. 7A-7F illustrate a process for creating a Pip, according to principles of the disclosure;

FIGS. 8A-8F are example illustrations for enabling direct annotation of images and for associating annotated images and non-annotated images with a Pip, according to principles of the disclosure;

FIGS. 9A-9C illustrate images associated with real-world locations and a Pip, according to principles of the disclosure;

FIG. 10 is an illustration of a dashboard 500 accessible via portal 825 from a computer-based device, according to principles of the disclosure;

FIG. 11 is an illustration of a graphical user interface showing a page of detailed information concerning active users, according to principles of the disclosure;

FIG. 12 is an illustration of a graphical user interface for managing teams and for adding teams to the system, according to principles of the disclosure;

FIG. 13 is an illustration of a graphical user interface for changing a role from one team to another team, according to principles of the disclosure;

FIG. 14 is an illustration of a task builder graphical user interface tool for providing a step-by-step process that can be associated with Pips in real-world locations, according to principles of the disclosure;

FIGS. 15A-15C, are illustrations of a task builder graphical user interface tool to define an example flow process, according to principles of the disclosure;

FIG. 16 is an example graphical user interface for assigning a task flow to a Pip, according to principles of the disclosure;

FIG. 17 is an example graphical user interface 700 for adding videos and URLs to Pips, according to principles of the disclosure;

FIG. 18 is an example graphical user interface showing a pop-up window when the “Add Media” Icon is selected, according to principles of the disclosure;

FIG. 19 is a block diagram of an example system architecture suitable for carrying out the operations, processes and features herein, according to principles of the disclosure;

FIG. 20 is a flow diagram of a process of providing augmented reality to a real world location, the steps performed according to principles of the disclosure; and

FIG. 21 is a flow diagram of a process of providing digital content and augmented reality information to a mobile device, the steps performed according to principles of the disclosure.

### DETAILED DESCRIPTION OF THE DISCLOSURE

The disclosure and the various features and advantageous details thereof are explained more fully with reference to the non-limiting embodiments and examples that are described and/or illustrated in the accompanying drawings and detailed in the following description and appendix. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the disclosure. The examples used herein are intended merely to facilitate an understanding of ways in which the disclosure may be practiced and to further enable those of skill in the art to practice the embodiments of the disclosure. Accordingly, the examples and embodiments herein should not be construed as limiting the scope of the disclosure.

A “computer”, also referred to as a “computing device,” as used in this disclosure, means any machine, device, circuit, component, or module, or any system of machines, devices, circuits, components, modules, or the like, which are capable of manipulating data according to one or more instructions, such as, for example, without limitation, a processor, a microprocessor, a central processing unit, a general purpose computer, a super computer, a personal computer, a laptop computer, a palmtop computer, a notebook computer, a desktop computer, a workstation computer, a server, or the like, or an array of processors, microprocessors, central processing units, general purpose computers, super computers, personal computers, laptop computers, palmtop computers, cell phone, notebook computers, desktop computers, workstation computers, servers, or the like. Further, the computer may include an electronic device configured to communicate over a communication link. The electronic device may include, for example, but is not limited to, a mobile telephone, a personal data assistant (PDA), a mobile computer, a stationary computer, a smart phone, mobile station, user equipment, or the like.

A “server”, as used in this disclosure, means any combination of software and/or hardware, including at least one application and/or at least one computer to perform services for connected clients as part of a client-server architecture. The at least one server application may include, but is not limited to, for example, an application program that can accept connections to service requests from clients by sending back responses to the clients. The server may be configured to run the at least one application, often under heavy workloads, unattended, for extended periods of time with minimal human direction. The server may include a plurality of computers configured, with the at least one application being divided among the computers depending upon the workload. For example, under light loading, the at least one application can run on a single computer. However, under heavy loading, multiple computers may be required to run the at least one application. The server, or any if its computers, may also be used as a workstation.

A “database”, as used in this disclosure, means any combination of software and/or hardware, including at least one application and/or at least one computer. The database may include a structured collection of records or data organized according to a database model, such as, for example, but not limited to at least one of a relational model, a hierarchical model, a network model or the like. The database may include a database management system application (DBMS) as is known in the art. The at least one application may include, but is not limited to, for example, an application program that can accept connections to service requests from clients by sending back responses to the clients. The database may be configured to run the at least one application, often under heavy workloads, unattended, for extended periods of time with minimal human direction.

A “network,” as used in this disclosure, means an arrangement of two or more communication links. A network may include, for example, a public network, a cellular network, the Internet, a local area network (LAN), a wide area network (WAN), a metropolitan area network (MAN), a personal area network (PAN), a campus area network, a corporate area network, a global area network (GAN), a broadband area network (BAN), any combination of the foregoing, or the like. The network may be configured to communicate data via a wireless and/or a wired communication medium. The network may include any one or more of the following topologies, including, for example, a point-to-point topology, a bus topology, a linear bus topology, a distributed bus topology, a star topology, an extended star topology, a distributed star topology, a ring topology, a mesh topology, a tree topology, or the like.

A “communication link”, as used in this disclosure, means a wired and/or wireless medium that conveys data or information between at least two points. The wired or wireless medium may include, for example, a metallic conductor link, a radio frequency (RF) communication link, an Infrared (IR) communication link, an optical communication link, or the like, without limitation. The RF communication link may include, for example, WiFi, WiMAX, IEEE 802.11, DECT, 0G, 1G, 2G, 3G or 4G cellular standards, Bluetooth, or the like.

The terms “including”, “comprising” and variations thereof, as used in this disclosure, mean “including, but not limited to”, unless expressly specified otherwise.

The terms “a”, “an”, and “the”, as used in this disclosure, means “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

Although process steps, method steps, algorithms, or the like, may be described in a sequential order, such processes, methods and algorithms may be configured to work in alternate orders. In other words, any sequence or order of steps that may be described does not necessarily indicate a requirement that the steps be performed in that order. The steps of the processes, methods or algorithms described herein may be performed in any order practical. Further, some steps may be performed simultaneously.

When a single device or article is described herein, it will be readily apparent that more than one device or article may be used in place of a single device or article. Similarly, where more than one device or article is described herein, it will be readily apparent that a single device or article may be used in place of the more than one device or article. The functionality or the features of a device may be alternatively embodied by one or more other devices which are not explicitly described as having such functionality or features.

A “computer-readable medium”, as used in this disclosure, means any medium that participates in providing data (for example, instructions) which may be read by a computer. Such a medium may take many forms, including non-volatile media, volatile media, and transmission media. Non-volatile media may include, for example, optical or magnetic disks and other persistent memory. Volatile media may include dynamic random access memory (DRAM). Transmission media may include coaxial cables, copper wire and fiber optics, including the wires that comprise a system bus coupled to the processor. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other non-transitory storage medium from which a computer can read.

Various forms of computer readable media may be involved in carrying sequences of instructions to a computer. For example, sequences of instruction (i) may be delivered from a RAM to a processor, (ii) may be carried over a wireless transmission medium, and/or (iii) may be formatted according to numerous formats, standards or protocols, including, for example, WiFi, WiMAX, IEEE 802.11, DECT, 0G, 1G, 2G, 3G, 4G or 5G cellular standards, Bluetooth, or the like.

The term “placed information point” (Pip) as used herein refers to a precise location in 3-D physical space, for which a visual digital overlay, or augmented overlay, may be presented on a display device for viewing by a user. The Pip may be located in 3-D space by placement of a Pip code at a real world location. The Pip code comprises a created code, similar to a QR code, placed on any physical device or the real world physical location, and provides a 0-0-0 origin point for the physical space proximate the physical device or real-world location, usable by the ARCore® software from Google LLC, the Microsoft Mixed Reality Toolkit® software by the Microsoft Corporation, the ARKit® software from Apple Corporation and visual-inertial odometry. The created Pip code may be a printed label, or otherwise created by other means such as in digital format, to be readable and accessible by a camera type device. The Pip code when read by a camera-equipped device may be used to access digital content, e.g., documents, photos, videos, text, audio, graphs, 3D models, 3D assets, GPS data, mapping data, sensor data, hyper-links, information, a uniform resource locator (URL), and/or the like, in a database that is pre-assigned and associated with the Pip. The digital information may then be displayed on a display (or played by an appropriate device for the particular digital content, such as an audio player) on demand on a device such as a mobile cell phone, a tablet computer, wearable computer such as head-mounted displays (HMD), or other computing device or similar devices.

The system and methods described herein provide for creating, managing and accessing spatially located information utilizing augmented reality and web technologies to resolve these problems by giving people the ability to quickly locate and access correct information as it relates to real-world locations and objects within them. Moreover, content created and managed according to principles herein may ensure accessibility both at the real-world location and remotely via the web.

The system and method herein may be implemented at least in part using the ARKit® from Apple Computer. The ARKit® provides a software platform for building augmented reality applications such as for placing or associating virtual objects in the physical world, thereby permitting a user to interact with those virtual objects by viewing a display such as, e.g., on a cell phone, on a head-mounted mobile device, a smart watch, headphones, or on a mobile computing device. The ARKit® software may execute at a server, or at both at a server and at one or more mobile devices in communication with the server. The system and method herein may be implemented at least in part using the ARCore® from Google LLC. The ARCore® provides a software platform for building augmented reality applications such as for placing or associating virtual objects in the physical world, thereby permitting a user to interact with those virtual objects by viewing a display such as, e.g., on a cell phone, on a head-mounted mobile device, a smart watch, headphones, or on a mobile computing device. The ARCore® software may execute at a server, or at both at a server and at one or more mobile devices in communication with the server. The system and method herein may be implemented at least in part using the Microsoft Mixed Reality Toolkit®. The Microsoft Mixed Reality Toolkit® provides a software platform for building augmented reality applications such as for placing or associating virtual objects in the physical world, thereby permitting a user to interact with those virtual objects by viewing a display such as, e.g., on a cell phone, on a head-mounted mobile device, a smart watch, headphones, or on a mobile computing device. The Microsoft Mixed Reality Toolkit®. software may execute a server, or at both at a server and at one or more mobile devices in communication with the server.

The mobile application on the mobile devices uses the Swift programming language that leverages the ARKit® augmented reality framework that combines motion tracking, camera scene capture, advanced scene processing, and display conveniences to simplify the task of building an augmented reality. The mobile application on the mobile devices uses the Java programming language that leverages the ARCore® augmented reality framework that combines motion tracking, camera scene capture, advanced scene processing, and display conveniences to simplify the task of building an augmented reality. The mobile application on the mobile devices may also use the C # programming language that leverages the Microsoft Mixed Reality Toolkit® augmented reality framework that combines motion tracking, camera scene capture, advanced scene processing, and display conveniences to simplify the task of building an augmented reality. The mobile application uses visual-inertial odometry. In this way, the mobile application, in conjunction with the server, give users and groups an ability to navigate spatially correlated content; and author access, manipulate digital content displayed in both augmented reality and 2D. Information may be filtered based on physical location and user permissions.

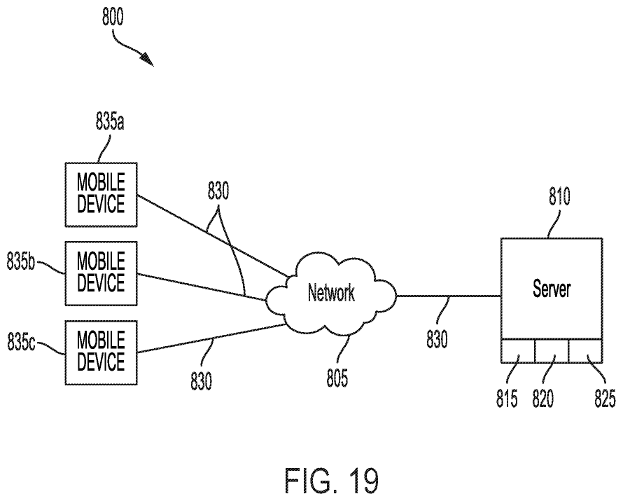

FIG. 19 is a block diagram of an example system architecture suitable for carrying out the operations, processes and features herein, according to principles of the disclosure. A server 810 may include a least one computer 815 for executing the software that when executed performs various operations and features herein, a database 820, accessible by the at least one computer 815, that maintains and provides storage for the various data, digital content, Pip data, Pip codes, user information, tasks, and any associated information as described herein. The server 810 may include a portal 825 that interfaces with a communication link 830 and network 805, which may be the internet. The server 810 may execute the ARKit®, ARCore®, or Microsoft Mixed Reality Toolkit® software and application features described herein in conjunction with application software executing on one or more computer-based mobile devices 835a-835c that provide at least portions of the feature operability described herein. The mobile devices 835a-835c, which also may include mobile devices 200, may be camera-equipped mobile devices and may be connected via a network 805 by a communication link 830 to the portal 825 at server 810.

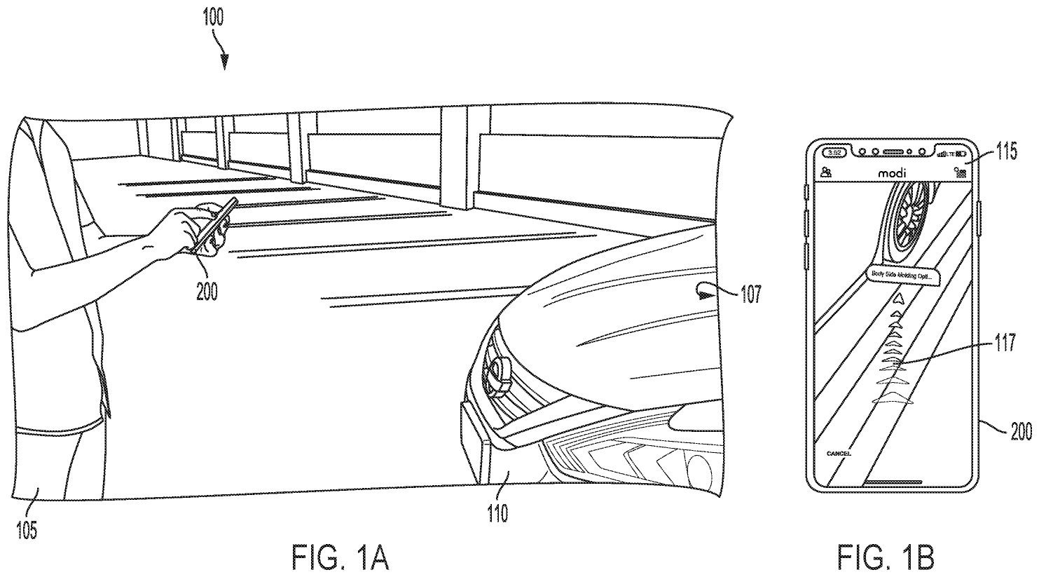

FIG. 1A is an example illustration of a person looking at a physical object to read a Pip using a camera-equipped device, generally denoted as 100, according to principles of the disclosure. In FIG. 1A, a person 105 is shown looking at a physical object, in this example a car 110, to read a Pip code 107 placed at a location on the car by using a mobile camera-equipped device 200. The Pip code, explained in more detail below, may be a readable label previously placed anywhere on the car, such as, e.g., near the windshield of the car. FIG. 1B is an example illustration of augmented reality information 115 displayed on mobile camera-equipped device 200. After reading the Pip code 107, the Pip code permits accessing augmented reality information 115 that may be displayed, in this example, while also directing a user to a particular location on the car in question. The Pip code 107 may be used to acquire the augmented reality information from a database, such as a remote database over a communication link, such as, e.g., a cell network data link, to locate augmented reality information related to the Pip code 107 and may present a map 117, i.e., the arrows, to the particular location of the car, in this example, a body side molding. Additional data may be displayed to a user of the mobile camera-equipped device 200 related to the body side molding, perhaps for a training purpose, a maintenance purpose, or other purpose.

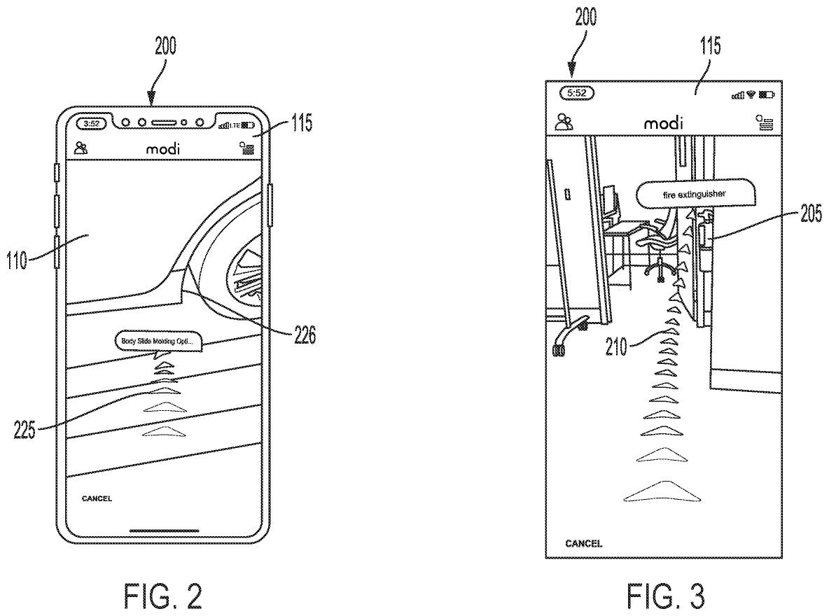

FIG. 2 is an example illustration of augmented reality information 115 of FIG. 1B re-displayed in relation to the car 110, according to principles of the disclosure. Augmented reality information 115 may be re-presented in real-time in a proper orientation as the mobile camera-equipped device 200 is moved by a user about the car 110. The augmented reality application running in the mobile camera-equipped device 200 may track motion from the origin point of the Pip code 107 and may adjust or re-present for a user the augmented reality information 115 to re-orient the image in relation to the car, showing a different angle in this example, showing where the body side molding 226 is located. As can be seen in FIG. 2, the map 225 has a new orientation as compared with FIG. 1B, in relation to the car 110 and the Pip code 107 location. The Pip codes herein, such as Pip code 107, may be applied to a physical object in a real-world location. ARCore®, Microsoft Mixed Reality Toolkit®, ARKit® provides a capability for tracking movement of the mobile camera-equipped device 200 using visual inertial odometer, and using the Pip code 107 origin point as location 0-0-0 (i.e., the initial x-y-z coordinates) in 3D space proximate the car 110. Moreover, a user can initiate an inquiry to locate where anything related to the car may be located in relation to the origin (0-0-0). Visual inertial odometer may be used prior to displaying the augmented reality information to re-orient the image presentation as a mobile device moves in relation to the origin point.

FIG. 3 is another example illustration of augmented reality information 115 displayed in relation to a physical object, e.g., a fire extinguisher 205, by using a mobile camera-equipped device 200, according to principles of the disclosure. A Pip code would have been previously scanned, perhaps placed, e.g., at a known location of the entranceway of the building or at a known location of a building floor, which resulted in the augmented reality information to be displayed including showing a map 210 for assisting in locating the fire extinguisher 205 associated Pip. Additional digital information may be provided to the mobile camera-equipped device 200 for viewing by a user such as information on how to remove, repair, or provide maintenance to the fire extinguisher 205. As a user moves, the image may be re-presented on a display to reflect the motion. As a user completes a task, a job, updates Pips or attaches media to Pips, the completion is automatically recorded.

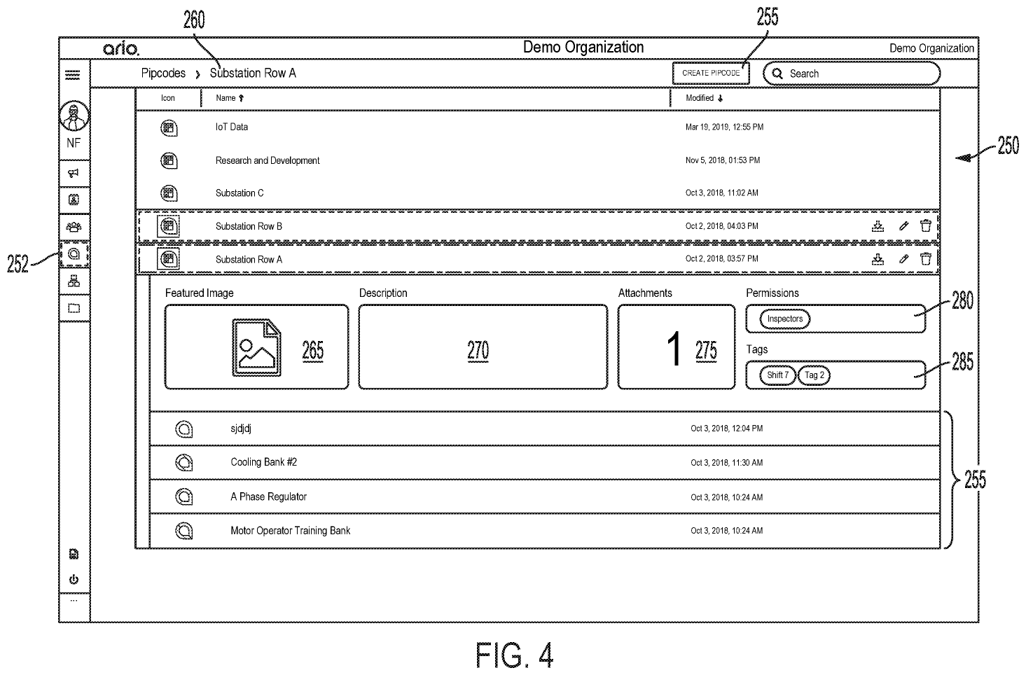

FIG. 4 is an illustration of an example graphical user interface 250 for managing a Pip through a web portal, configured according to principles of the disclosure. This illustration is related to identifying locations in a power sub-station where there may be multiple lines coming in; Row A is one of those lines. A Pip for Substation Row A may be defined and managed by selecting the Pip icon 252. Substation Row A is a location within a power substation. A Pip code may be created via selection 255 for associating with Substation Row A, the Pip code is named Substation Row A. Other Pip codes associated with the power station may also be presented for ongoing management 250. Moreover, Substation Row A 260 may have a hierarchy of other Pip codes 250 and/or Pips 255 defined that are children of Substation Row A 260, and also exist in the physical environment of Substation Row A. These Pips 255 once defined, may be accessed by users through access of the Pip code, Substation Row A 260, or directly via specific Pip codes or Pips for each of the children, e.g., cooling bank #2, a Phase regulator, or Motor Operator Training Bank. Data associated with the Pip codes may be managed here. Clicking on any of the children will provide a new display similar to the display in FIG. 4 for accessing and managing the information related to the child Pip codes or Pips, including images 265, attachments 275 and permissions for each child Pip code and Pip. There may be multiple layers of children Pips.

A physical location image, once captured, may be associated with a Pip and a Pip code automatically by background processing at the portal, the associated image may be presented in the featured image 265. In this manner, a user in the field after scanning a Pip code may see the same image as an administrator for managing the Pips and Pip codes. In this example, the image may be, e.g., an image of one or more transformers. A description of the Pip and associated image may be created and viewed in a description area 270. Moreover, one or more attachments 275, e.g., digital data, documents, a hyperlink, may be associated or linked with the particular Pip code being defined or managed. The one or more attachments may be data for one or more of maintenance material, training material, warning information, procedures, schedules, sensor data, manufacturer's manuals, links to other resources on the Internet, or nearly any type of information needed by a user in the field for performing or attending to a task. Further, the one or more attachments may be updated, removed or replaced. A permission field 280 may specify the type of personnel having sufficient access rights to access the defined data including attachments.

A tag field 285 may be used to indicate which class or group of personnel would be interested in a particular Pip. For example, a tag 285 may indicate that the Pip is relevant to an electrician. A different tag may indicate that the Pip is relevant to heating personnel or plumbers. In this way, personnel can select an appropriate tag based on their own category; then all Pips associated with that selected tag will be displayed, while visually filtering out Pips that are not related to a particular tag. So, in the field, a user can easily recognize only relevant Pips related to their category of work, such as electrical, and then, if needed, accessing any associated attachments 275 accordingly. This filtering applies to augmented reality visualization of the digital overlay of Pips through the mobile display. Any number of tags can be applied to a Pip as required for different classes, categories or types of personnel. A tag hierarchy can be established to include more than one job category so that different types of personnel might see the same or overlapping Pips. For example, heating and cooling might include certain electrical tags.

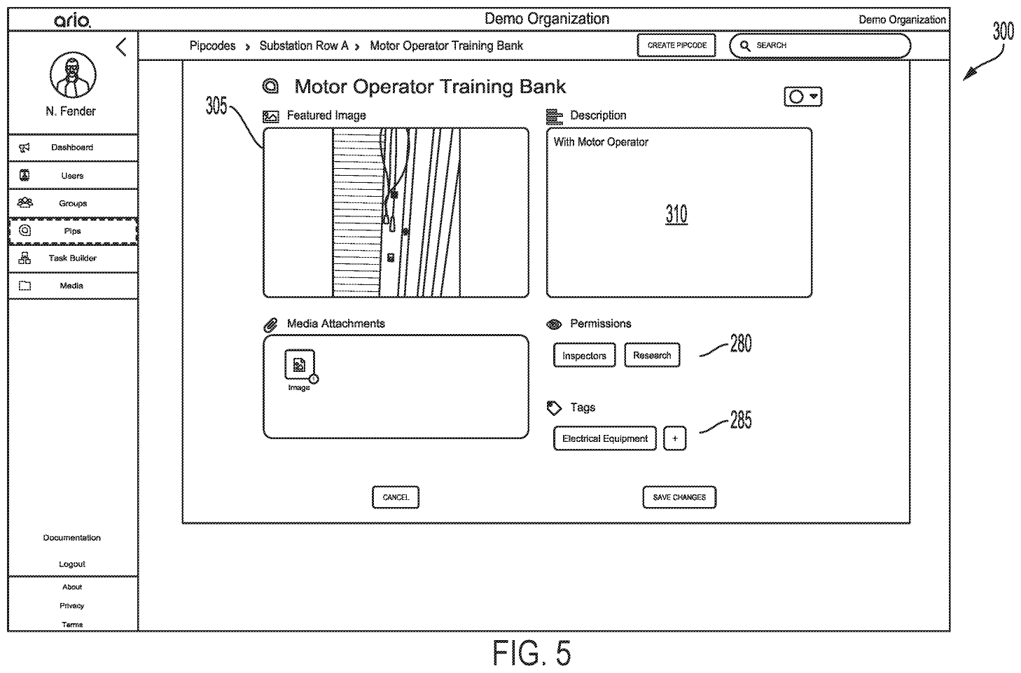

FIG. 5 is an example of managing media attachments for Pips that are in real-world locations, according to principles of the disclosure. This page 300 may be reached through the web portal from the graphical user interface 250 in FIG. 4, such as by selecting the pencil image associated with one of the Pips. In this example, the Motor Operator Training Bank Pip is selected from the child Pip 250, followed by selecting the pencil icon on the new page. The image 305 is of a training bank associated with Substation Row A. A description 310 may be added describing the Motor Operator Training Bank Pip. Who can view the data is controlled via the permissions icon 280, with tags 285 applied, both as described earlier. Media attachments may be added as described earlier, and many include video, text, manuals, documents, pdfs, links, URLs, or the like.

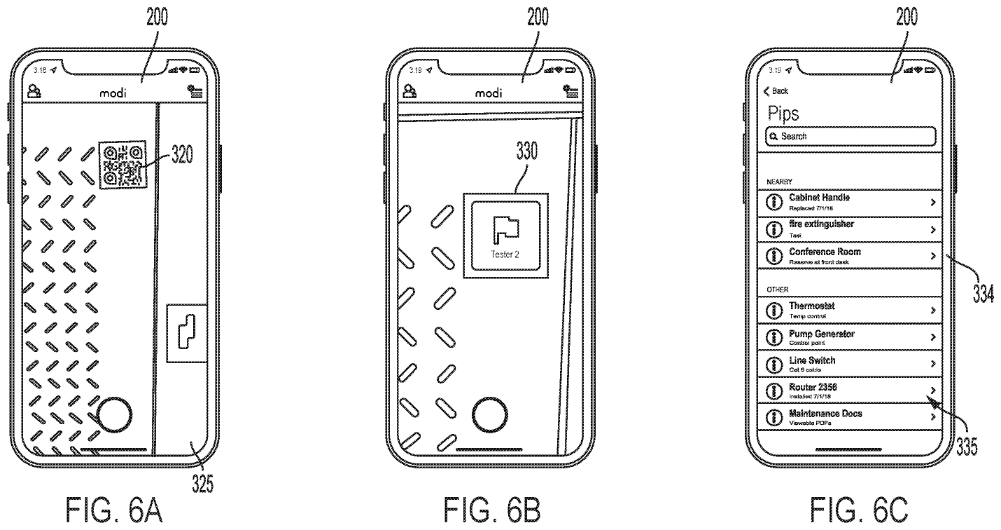

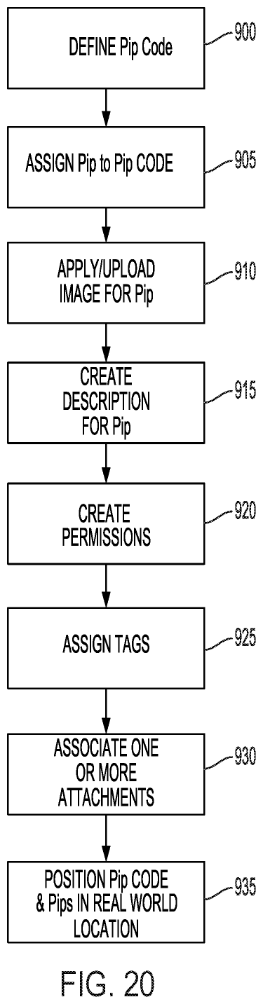

FIG. 6A is an illustration of scanning a Pip code at a real-world location, according to principles of the disclosure. A user may scan a Pip code 320 at a real-world object using, e.g., a camera equipped mobile device, in this example, the associated real world object is a cabinet 325. The Pip code 320 may be similar to, or may be, a Quick Response (QR) code and provides unique identifying information that can be used to locate a Pip predefined in a database, such as database 820 (FIG. 20). In the real world, the Pip code 320 defines or is associated with location coordinate 0-0-0 for the ARKit®, ARCore®, Microsoft Mixed Reality Toolkit software 825 (FIG. 20). FIG. 6B is an illustration of a Pip code being acknowledged after being scanned by the mobile device 200 and received by the server 810 (FIG. 20), according to principles of the disclosure. The icon 330 for the Pip code 320 may change to indicate that the scan succeeded, and may be updated to indicate the actual name of the Pip Code, in this example “Tester 2.” FIG. 6C is an illustration of children Pips 335 that are associated with the Pip Code “Tester 2,” and may be viewed by a user by selecting the Icon 334.

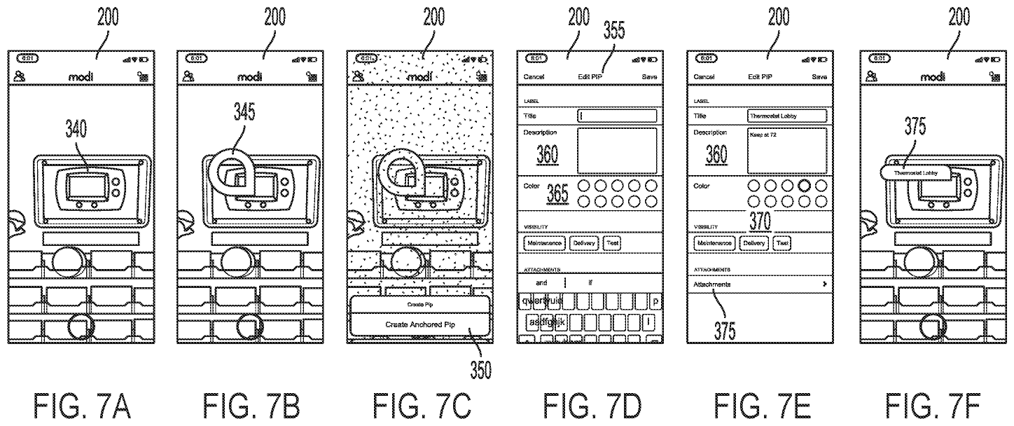

FIGS. 7A-7F illustrate a process for creating a Pip, according to principles of the disclosure. FIG. 7A shows a thermostat 340 in a viewfinder of a camera of a mobile device 200. In FIG. 7B, a user may determine placement of a Pip 345 that it is to be anchored at an upper left corner of the thermostat 340. In FIG. 7C, a user may create and anchor the Pip by selecting the Icon 350, the display may change contrast during this process. In FIG. 7D, a user may edit 355 the created Pip including adding a description 360 and selecting a color 365 for the Pip scheme. In FIG. 7E, a user may designate a Pip title/name, i.e., “Thermostat Lobby,” and one or more visibility tag 370, which can be used to filter data to specific personal or users. Attachments 375 may be added at this time to associate any type of digital content to this Pip 345. Attachments may include hyper-links, URLs, files, text, video, manuals, photos, diagrams, and the like. In FIG. 7F, a final digital overlay 375 is produced for Pip named “Thermostat Lobby.” The title “Thermostat Lobby” is shown anchored to the upper left corner of the thermostat 340. This also provides a specified X,Y,Z coordinate for the 3D controls in relation to the parent Pip code's 0,0,0 origin.

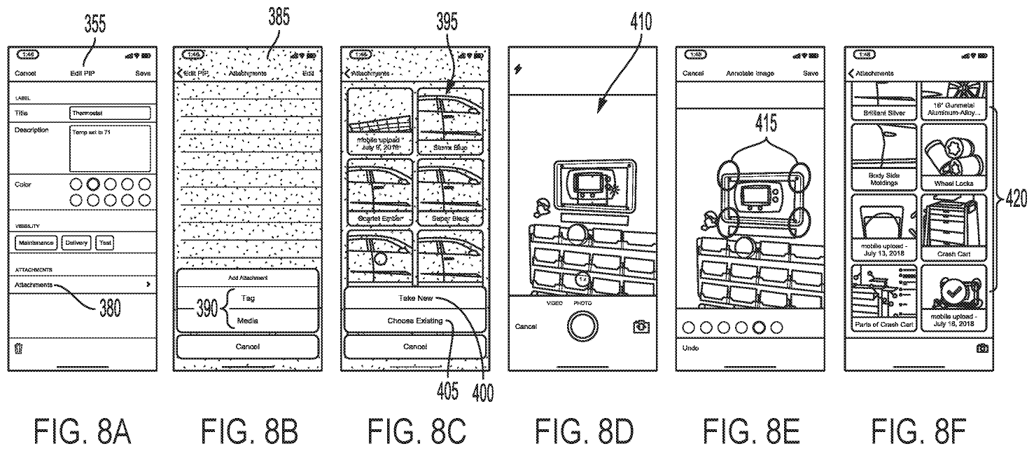

FIGS. 8A-8F are example illustrations for enabling direct annotation of images and for associating annotated images and non-annotated images with a Pip, according to principles of the disclosure. FIG. 8A is similar to the FIG. 7E, and permits a user to edit a Pip by selecting the edit icon 350. Alternatively, attachments may be edited by selecting Icon 380, which may bring up a new image 385 (FIG. 8B), which may greyed-out. In FIG. 8B, tags and/or media 390 may be defined as attachments. In FIG. 8C, a new image may be taken 400 (via a camera) or an existing image 395 may be chosen 405 and made as an attachment for the current Pip.

FIG. 8D illustrates a process for annotating an existing image, according to principles of the disclosure. An existing image 410 may be selected for annotation. In FIG. 8E, the circles 415 may be added as annotations to the image 410. Instructions may be included as an attachment or as annotation in the image to convey that the thermostat may be accessed by removing screws indicated by the circles 415. FIG. 8F is an illustration of other types of additional image content 420 that may be selected and added as an added attachment to a Pip. Generally, attachments may include any digital media type, assessable directly, or accessible indirectly over a network, at a user mobile device in the field.

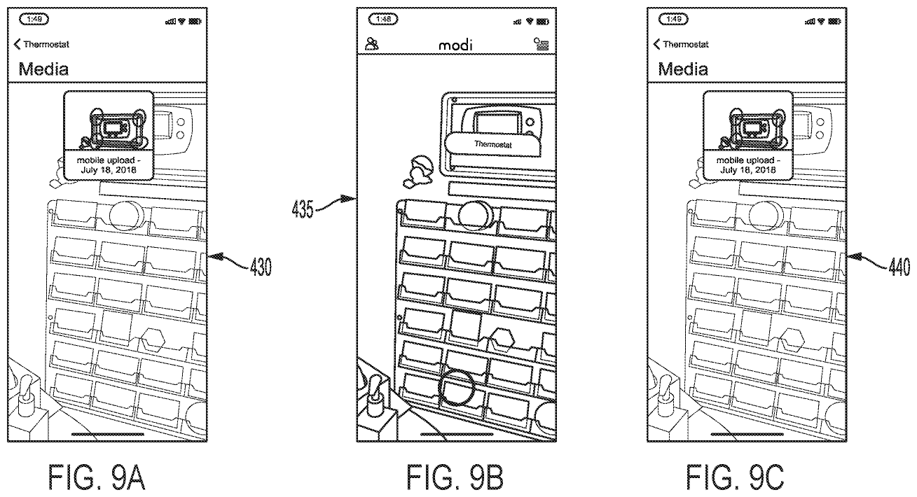

FIGS. 9A-9C illustrate images 430, 435, 440 associated with real-world locations and a Pip, according to principles of the disclosure. FIG. 9A shows an image associated with a Pip in a real-world location that has been annotated and viewable on a user device such as by scanning a Pip code. FIG. 9B is an illustration of a Pip named “Thermostat” with augmented overlay 435, according to principles of the disclosure. FIG. 440 illustrates an annotated image 440 associated with the Pip “Thermostat” of FIG. 9B and can be assessed through the Pip at the real-world location using a Pip Code, or can be accessed via a portal 825 at the server 810 (FIG. 20).

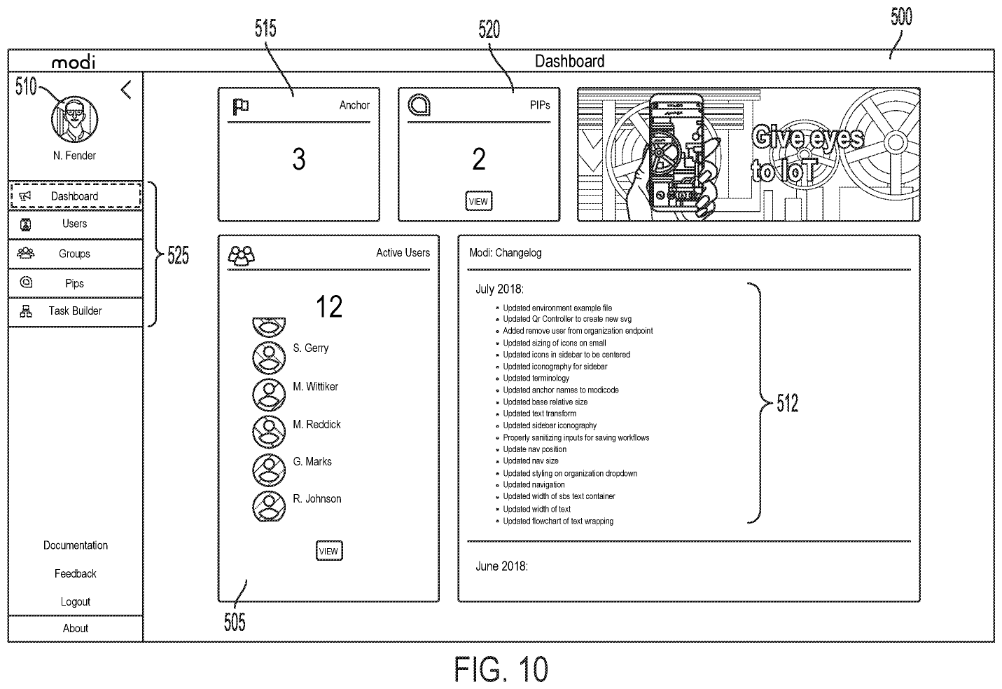

FIG. 10 is an illustration of a dashboard 500 accessible via portal 825 from a computer-based device, according to principles of the disclosure. The dashboard 500 displays information for a particular user 510, who might be an administrator for system 800, that has logged-in and been authenticated to access the portal 825. A user may have access rights assigned that permit access to certain areas and prohibit access to some areas of the portal as defined by access rights. The user may select from among different icons 525 such as a “Dashboard” icon (being depicted in FIG. 10), a “Users” icon, a “Groups” icon, and a “Task Builder” icon. The user 510 may view any or all Pips via Pip Icon 520 that the user has access rights for viewing. The Icon 520 may indicate a number of available Pips. An Anchor Icon 515 indicates the number of anchored Pips which are Pip codes.

A summary window 505 of active users having accounts in the system 800 may be displayed with a current count, any of which may be viewed in detail by selecting the “View” Icon in the summary window 505. A log 512 of recent activity from both the portal 825 and from mobile application such as used on any of the mobile devices, augmented reality wearables, head-mounted displays, headphones and/or smart watches. The log 512 may be displayed organized by a time, such as month, week, or the like.

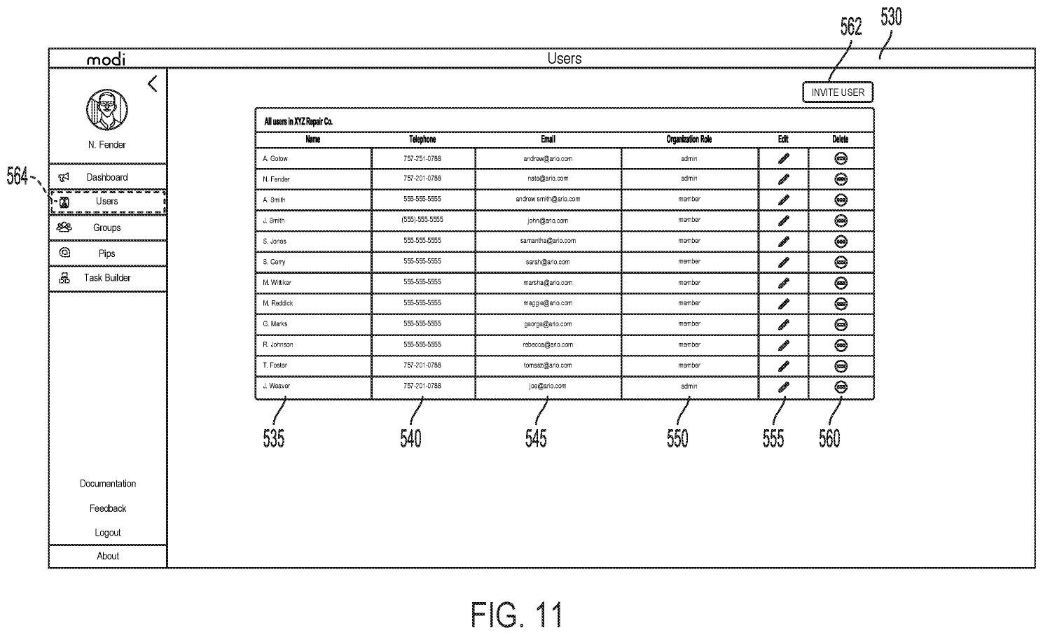

FIG. 11 is an illustration of a graphical user interface showing a page 530 of detailed information concerning active users, according to principles of the disclosure. This page 530 may be accessed via Icon 564 and may include a listing of the names of active users, shown in column 535, associated telephone number shown in column 540, Email shown in column 545, and Organization Role, shown in column 550. An administrator may edit information associated with each individual by selecting an appropriate Edit Icon, shown in column 555. An individual may be deleted from the system 800 by selecting the appropriate “Delete” Icon shown in column 560. A new user may be “Invited” by selecting the “Invite” Icon 562.

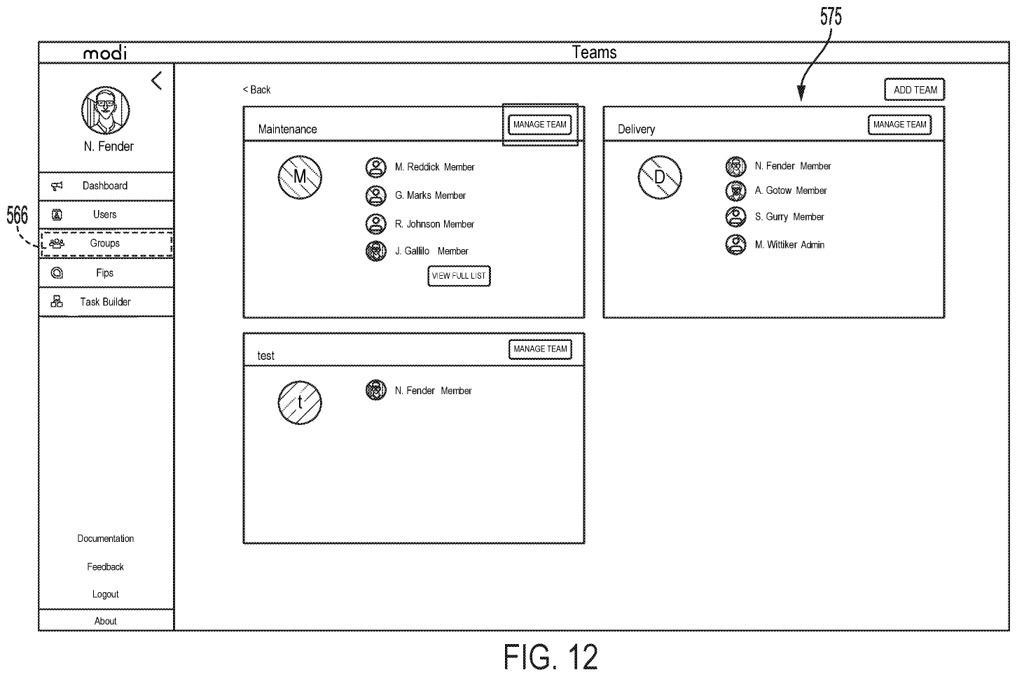

FIG. 12 is an illustration of a graphical user interface for managing teams and for adding teams to the system 800, according to principles of the disclosure. An administrator may view, add, remove or reassign a user from any team. Users may be grouped into teams by selecting a “Group” Icon 566. Users may be assigned to or removed from defined teams, e.g., “Maintenance” team, “Delivery” team 575 or “test” team, as shown. In this way, a user's role may be associated with tags, e.g., tags 285, that control what type of attachments and digital content can be viewed/filtered.

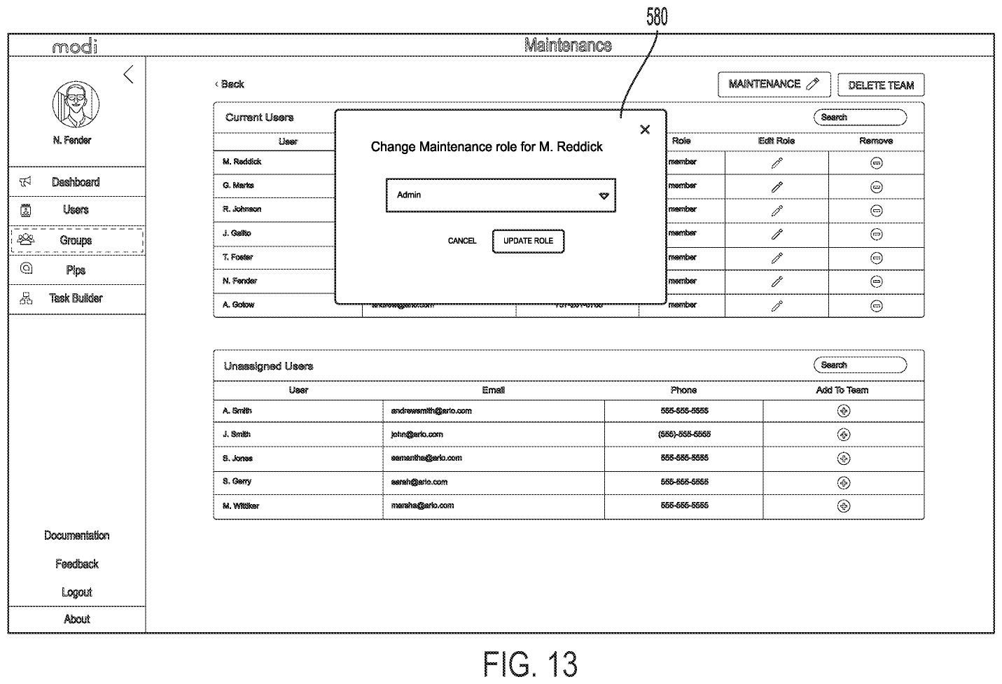

FIG. 13 is an illustration of a graphical user interface for changing a role from one team to another team, according to principles of the disclosure. In this example, M. Riddick is being assigned 580 a new role on the “Admin” team.

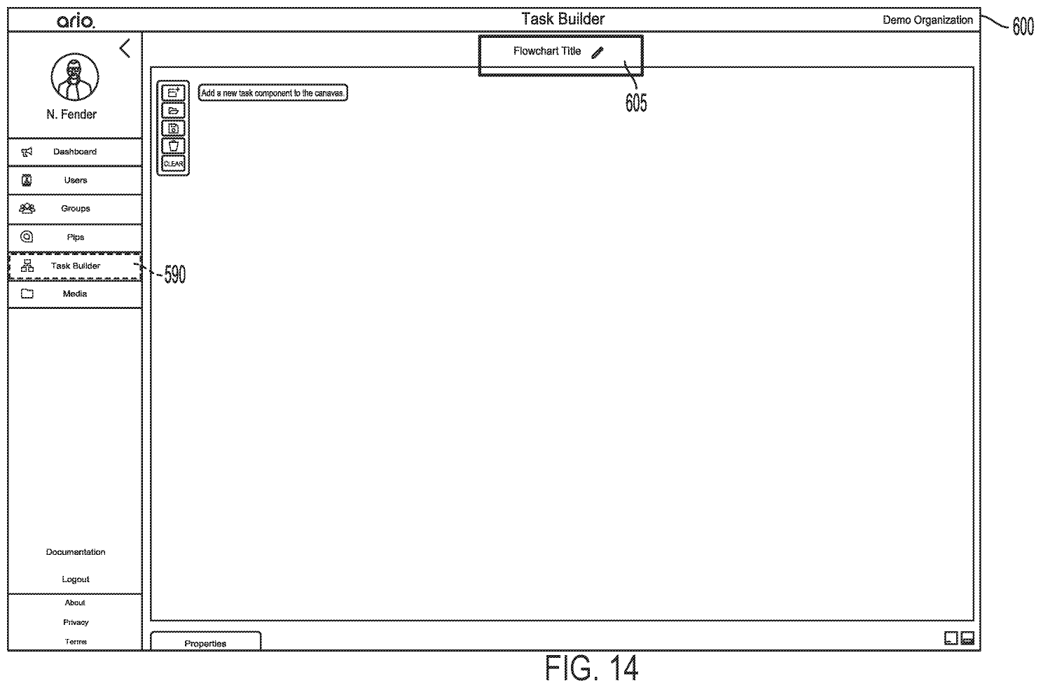

FIG. 14 is an illustration of a task builder graphical user interface tool for providing step-by-step process that can be associated with Pips in real-world locations, according to principles of the disclosure. The task builder may be entered via the “Task Builder” Icon 590, and a Title 605 of a task flow provided.

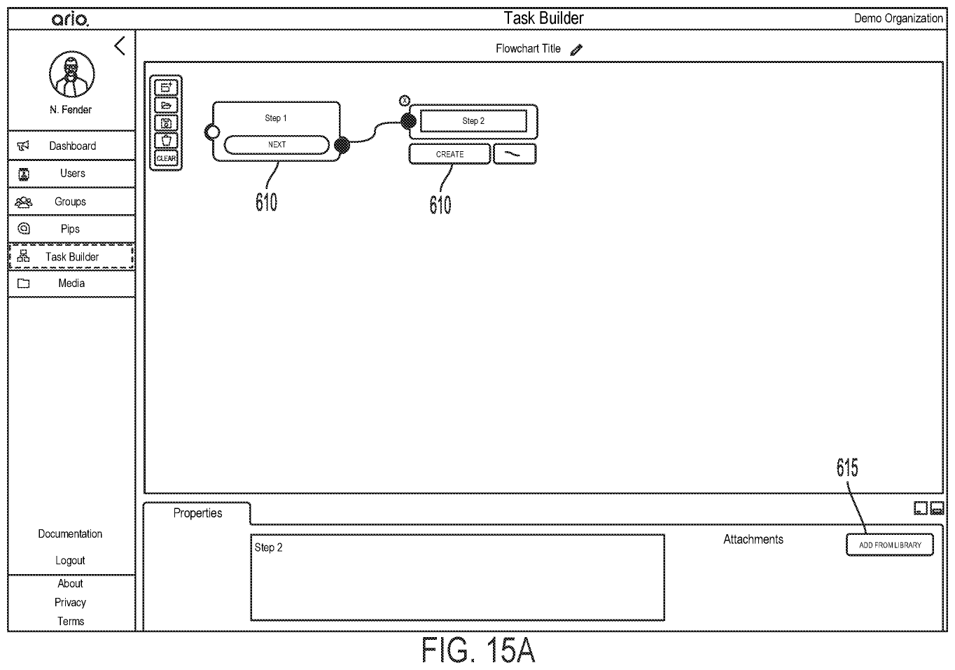

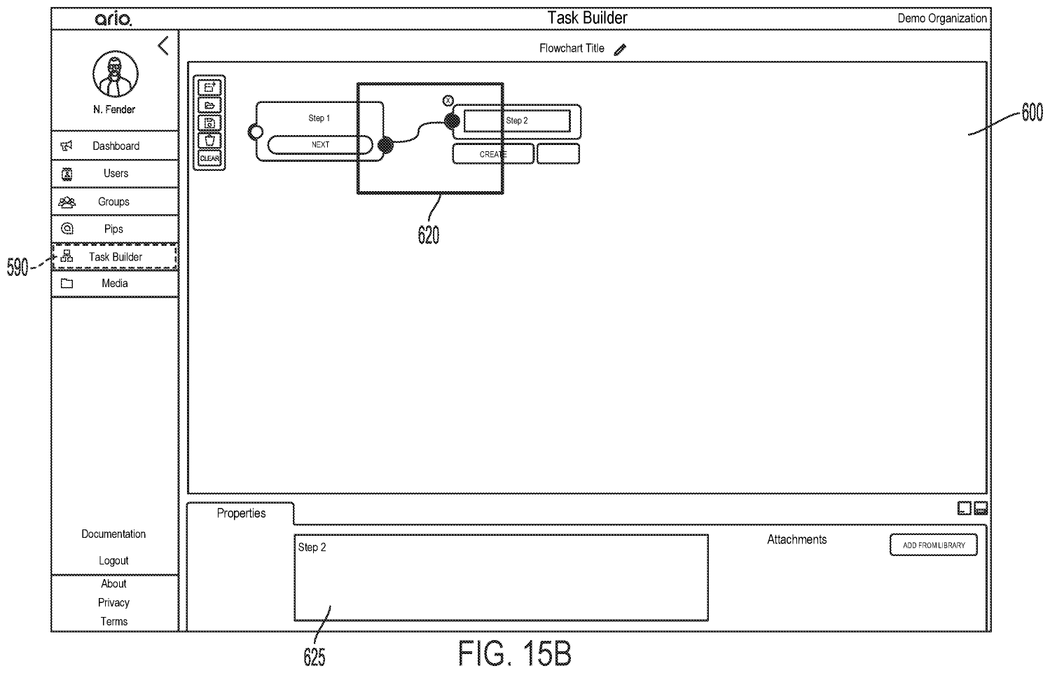

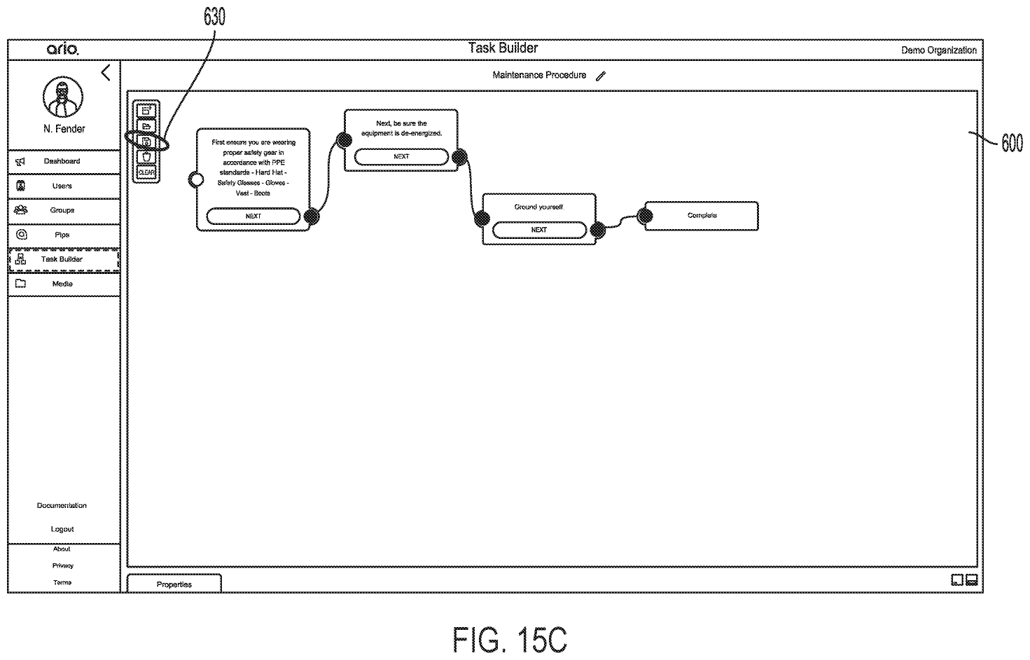

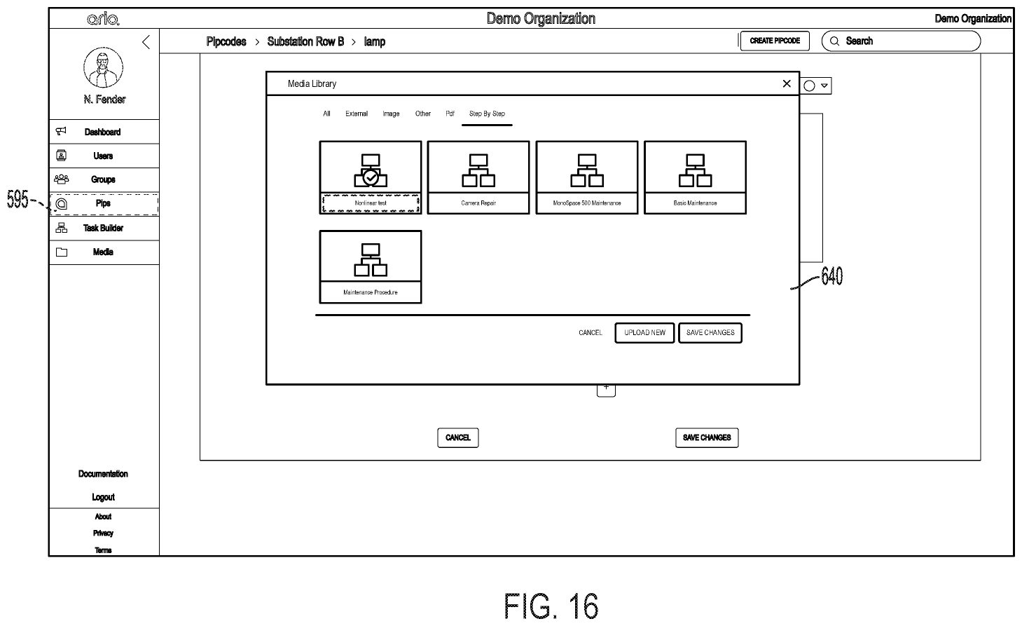

FIG. 15A, is an illustration of a task builder graphical user interface tool to define an example flow process, according to principles of the disclosure. The process may include defining step-1 610, then step 620 which is a linear process. Attachments may be provided for each step such as providing attachments from the library using “Add from Library” Icon 615. The step-by-step processes, i.e., a task, may be a set of instructions on how something in the real world should be accomplished. The task may be linear, from step 1 to step 2 to step 3, or the process may be non-linear. So, in a non-linear process, if, e.g., step 1 asks a question concerning a condition in the real-world, then the next step may be step 2 or may be step 3, depending on the answer. Each step may have attachments associated to provide information such as maintenance instructions for a particular step. Steps are connectable using a draggable graphical user interface. FIG. 15B illustrates that the two steps 1 and 2 are connected together 620. This assists in controlling a user's behavior in the real world, such as, e.g., a maintenance repair. A description for a step, e.g., Step 2 (625) may be entered. FIG. 15C is a simplified example illustration 600 of a maintenance procedure constructed by the task builder tool. There are four steps shown; the steps instructing a user to observe safety gear, make sure equipment is de-energized, grounding themselves, and a complete step. The task may be saved to a media library using the Save Icon 630 for later assignment to Pips.

FIG. 16 is an example graphical user interface for assigning a task flow to a Pip, according to principles of the disclosure. A Pip may be selected via Pips Icon 595, and a listing 640 of available tasks may be viewed from the media library. Alternatively, a new task may be added to a category in the media library. A task may then be assigned to a Pip, in this example, the Pip titled “lamp.”

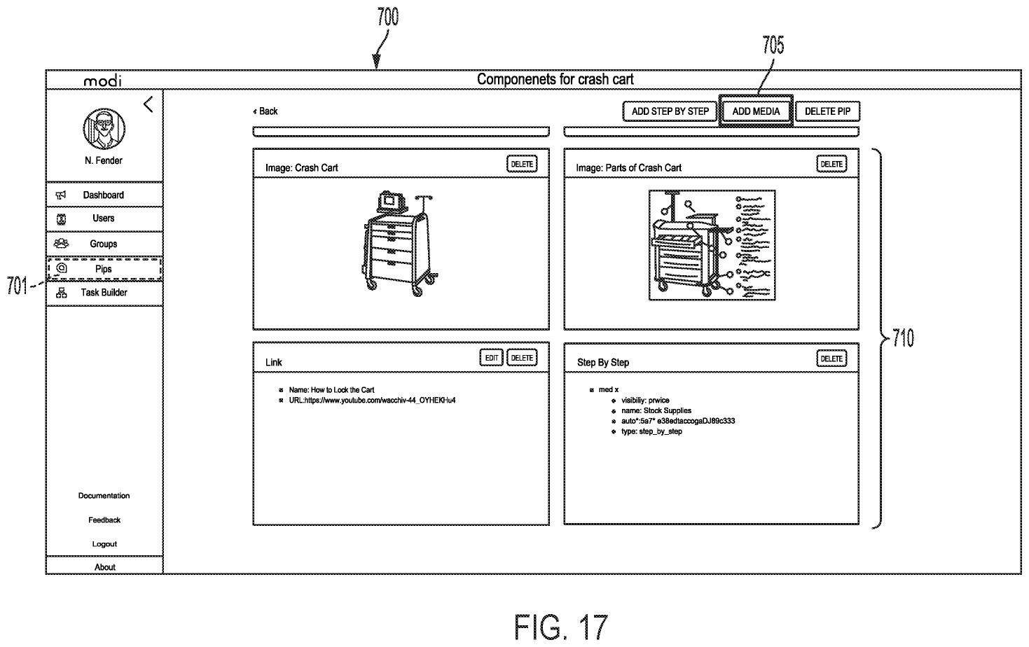

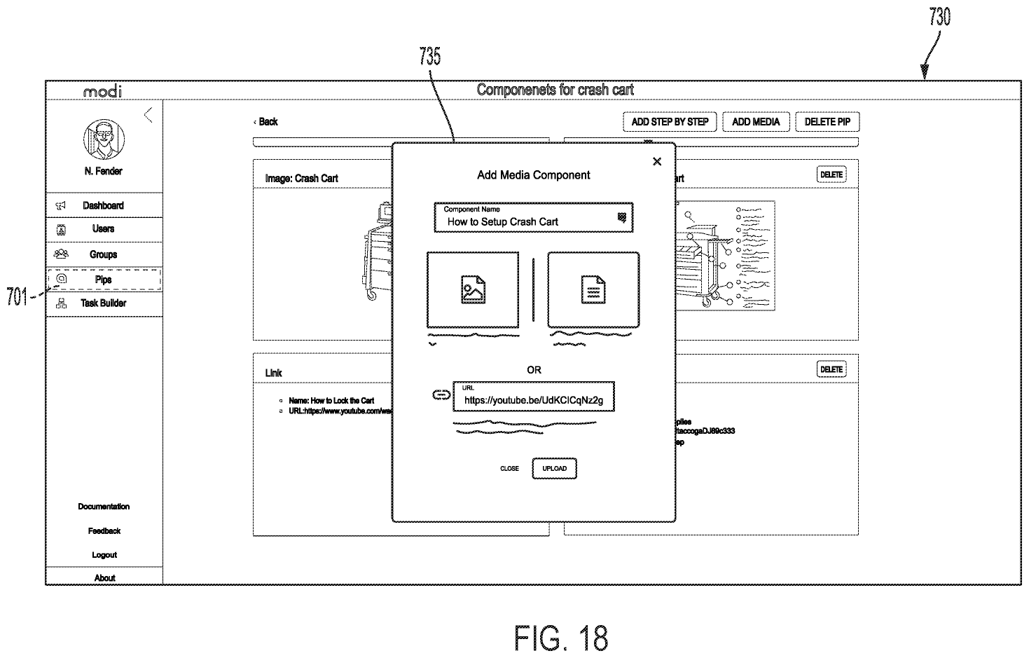

FIG. 17 is an example graphical user interface 700 for adding videos and URLs to Pips, according to principles of the disclosure. A user may enter this page via the Pips Icon 701. The “Add Media” Icon 705 permits any one of stored media 710 to be added to a Pip named “Crash Cart.” FIG. 18 is an example graphical user interface 730 showing a pop-up window 735 when the “Add Media” Icon 705 is selected, according to principles of the disclosure. A media component “How to Set-up Crash Cart” is selected, and/or, a URL may be selected and associated with the Pip “Crash Cart.” In this way, a name is given to the URL being assigned to the Pip that is in a real-world location. This sequence determines the URL access on the mobile devices.

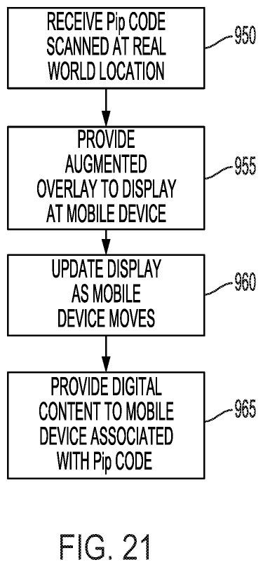

FIG. 20 is a flow diagram of a process of providing augmented reality to a real world location, the steps performed according to principles of the disclosure. The steps of FIGS. 20 and 21 (and any other flow diagram herein) may also represent a block diagram of the software components for performing the representative step when read from a computer-readable medium and executed by an appropriate computer. The flow diagram may also represent a computer program product that stores the respective software that when read and executed by a computer, performs the respective steps.

At step 900, one or more Pip codes may be created/defined for a real world location and maintained in a database such as database 820. At step 905, at least one Pip may be assigned to the Pip code. At step 910, one or more images may be uploaded for the Pip and maintained in a database such as database 820. At step 915, a description may be created and assigned to Pip. At step 920, one or more permissions may be created for one or more users to control access of information associated with a Pip. The permissions may be organized by teams or groups of users. At step 925, tags may be assigned to a Pip that provide an indicator of the type of user that may be concerned with the information and the Pip. Information can be filtered based on the tag and the type of user, e.g., by team or by group. At step 930, one or more attachments of digital content may be associate with the Pip. The digital content may include, but not limited to, e.g., documents, videos, annotations, URLs, hyper-links, photos, audio, and the like. At step, 935, a Pip code may be positioned in the real world at a location indicative of the Pip. The assigned Pip code may be a printed or otherwise a created tangible code readable by a camera-equipped mobile device.

FIG. 21 is a flow diagram of a process of providing digital content and augmented reality information to a mobile device, the steps performed according to principles of the disclosure. At step, 950, a Pip code information may be received at a server, e.g. server 810. The Pip code information identifies the specific Pip code location and permits identification of the associated Pip. The Pip code may be scanned by a mobile device at a real-world location. The mobile device may include a watch, a head-mounted device, headphones, a cell phone, a tablet computer, or any other camera-equipped computing device. In some embodiments, the Pip code may comprise an RFID tag, near-field tag, image recognition, or object recognition that is readable by an appropriate mobile device. At step 955, an augmented overlay may be provided on a display device at the mobile device. The augmented overlay may include variable perspective views of an object associate with a Pip. The variable perspective views may change as a user device moves about proximate the Pip code location. The augmented overlay may include a map showing a direction or a location of an object. Moreover, digital content may be supplied to the display device as associated with the Pip and Pip code. The digital content may include, but not limited to: instructional materials, videos, 3D models, 3D assets, photos, manuals, hyper-links, URLs, audio, documents, checklists, guides, bulletins, and the like. At step 960, a display image may be updated as the mobile device moves in a 3D relationship from the origin point of the Pip code to reflect motion of the mobile device. At step 965, digital content associated with the Pip code at and/or Pip may be provided to the mobile device augmenting reality. The digital content may include, but not limited to: manuals, hyper-links, URLs, video, photos, documents, 3D models, 3D assets, sensor data, diagrams, technical data, sequences or procedures or tasks, and the like.

While the disclosure has been described in terms of exemplary embodiments, those skilled in the art will recognize that the disclosure can be practiced with modifications in the spirit and scope of the appended claims. These examples are merely illustrative and are not meant to be an exhaustive list of all possible designs, embodiments, applications or modifications of the disclosure.

What is claimed is:

1. A computer-implemented method of providing augmented reality, comprising:
creating at a first computer a placed information point (Pip) and associating a Pip code with the Pip;
associating at the first computer digital content with the Pip and the Pip code;
receiving at the first computer, scanned information from a Pip code; and
providing by the first computer an augmented reality overlay for displaying on a display.

2. The computer-implemented method of claim 1, further comprising providing additional digital content associated with the Pip code for displaying on a display of a mobile device.

3. The computer-implemented method of claim 2, wherein the digital information or the additional digital content comprises at least one of: a manual, a video, a photo, a document, a 3D model, a 3D asset, sensor data, a hyper-link, a uniform resource locator (URL), audio, a guide, a technical bulletin and an annotated image.

4. The computer-implemented method of claim 1, wherein the additional digital content is filtered based on a tag so that only additional content is displayed based on an identifier associated with a user.

5. The computer-implemented method of claim 1, further comprising applying a permission to a plurality of users for the Pip to control access to the digital content associate with the Pip.

6. The computer-implemented method of claim 1, wherein the first computer is a server and the Pip, Pip code, digital content are stored in a database accessible by the server.

7. The computer-implemented method of claim 1, further comprising updating the augmented reality overlay to reflect movement of a mobile device relative to an origin point defined by the Pip code.

8. The computer-implemented method of claim 1, wherein in the step of providing augmented reality includes using visual-inertial odometry prior to providing the augmented reality for displaying on the display.

9. The computer-implemented method of claim 1, wherein the Pip is a child Pip and the additional digital content is associated with the child Pip.

10. The computer-implemented method of claim 1, further comprising receiving at least one tag definition at the first computer and associating the tag with a Pip to filter information based on a user identity or a group identity.

11. The computer-implemented method of claim 1, wherein the step of providing by the first computer the augmented reality overlay, provides the augmented reality overlay to a second computer for displaying on a display at the second computer.

12. The computer-implemented method of claim 1, wherein the first computer is a camera-equipped mobile device in communication with a server.

13. A system for providing augmented reality, comprising:
a first computer device operably connected to a database that stores data for defining at least one Pip, at least one Pip code, and digital content associated with the at least one Pip; and
a second computer device that is equipped to scan a Pip code and equipped to communicate the Pip code to the first computer,
wherein the first computer device provides at least one augmented overly to the second computer for displaying on a display.

14. The system of claim 13, wherein the Pip code establishes an origin point for providing changes in perspective view of the augmented overlay at the second computer device.

15. The system of claim 14, wherein the second computer device changes the perspective view of the augmented overlay as the second computer device moves, or the second computer device images a real-world location to provide images to be associated with a Pip.

16. The system of claim 13, wherein the first computer device manages users and establishes permissions for permitting access by users to the at least one Pip.

17. The system of claim 13, wherein the first computer device creates at least one child Pip associated with the at least one Pip.

18. The system of claim 13, wherein the first computer device provides the digital content to the second computer based on a scanned Pip code.

19. The system of claim 13, wherein the digital content comprises at least one of: a hyper-link, a URL, a file, text, a video, a manual, a photos, a 3D model, 3D assets, sensor data, a diagram.

20. A computer program product comprising software code in a computer-readable medium, that when read and executed by a computer, cause the following steps to be performed:
creating at a first computer a placed information point (Pip) and associating a Pip code with the Pip;
associating at the first computer digital content with the Pip and the Pip code;
receiving at the first computer, scanned information from a Pip code; and
providing by the first computer an augmented reality overlay for displaying on a display and providing additional digital content associated with the Pip.
